(19) United States
(12) Patent Application Publication
(10) Pub. No.: US 2010/0321346 A1
(43) Pub. Date: Dec. 23, 2010

(54) Electronic paper display device and method of driving the same

(75) Inventors: Kyoung Soo Chae, Suwon-si (KR); Hwan Soo Lee, Seoul (KR); Hye Yeon Cha, Yongin-si (KR); Hee Bum Lee, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/461,917

(22) Filed: Aug. 27, 2009

(30) Foreign Application Priority Data
Jun. 19, 2009 (KR) 10-2009-0055068

(51) Int. Cl. G09G 5/00

(52) U.S. Cl. 345/204

(57) ABSTRACT

The present invention relates to an electronic paper display device and a method of driving the same. The electronic paper display device may include: an electronic paper panel that displays an image; and a vibration member that generates vibration of the electronic paper panel.

### CROSS REFERENCES RELATED APPLICATIONS

The present application claims priority under 35 U.S.C. 119 and 35 U.S.C. 365 to Korean Patent Application No. 10-2009-0055068 (filed on Jun. 19, 2009), which is hereby incorporated by reference in its entirety.

### BACKGROUND OF THE INVENTION

1. Field of the Invention

The present invention relates to an electronic paper display device and a method of driving the same, and more particularly, to an electronic paper display device that has a vibration member generating a vibration of an electronic paper panel and a method of driving the same.

2. Description of the related art

As a next generation display device, a liquid crystal display (LCD), a plasma display panel (PDP), an electroluminescence, an electronic paper display device, etc. have been widely spread.

Among others, the electronic paper display device is flexibly bendable and is much cheaper than other display devices in view of its production costs.

Further, the electronic paper display device does not need a background illumination or a continuous recharging so that it can be driven with very little energy, having significantly excellent characteristics in energy efficiency.

Moreover, the electronic paper display device is clear and has a wide viewing angle, and is also able to have a memory function that displayed characters or images do not completely disappear even though power is instantly blocked. Therefore, the electronic paper display device has been expected to be broadly used in a wide variety of fields such as a foldable screen, an electronic wallpaper, etc. as well as print media such as books, newspapers or magazines.

Meanwhile, technical schemes capable of implementing the electronic paper display device have been largely divided into a scheme using a liquid crystal, an organic EL scheme, a reflection film reflective display scheme, an electrophoretic scheme, a twist ball scheme, an electrochromic scheme, a mechanical reflective display scheme, etc. and have been developed.

Among others, the electronic paper display device using the twist ball includes two electrodes and an elastomer sheet that is interposed between the two electrodes and to which the twist ball having an optical and electrical anisotropy is attached. At this time, dielectric liquid is coated on an outer circumferential surface of the twist ball.

Herein, the twist ball may be configured of a black hemisphere and a white hemisphere that are charged with different charges. With the electronic paper display device using such a twist ball, when voltage is applied to the two electrodes, the respective hemispheres of particles are rotated to face electrode surfaces of polarities opposite to each other inside the dielectric liquid according to the applied voltage direction, thereby displaying black and white.

Meanwhile, in order that the electronic paper display device is commercialized, power consumption rendered in displaying an image should be small. However, owing to the problem of intervals between the electrodes and the twist balls and the problem of the junction caused by attraction generated between the twist balls, the minimum threshold potential for starting the rotation of the twist balls cannot but be raised in the electronic paper display device.

Therefore, driving voltage of the electronic paper display device becomes high, such that the electronic paper display device cannot be driven with portable battery power.

### SUMMARY OF THE INVENTION

The present invention proposes to solve the problems that may occur in an electronic paper display device in the related art. It is an object of the present invention to provide an electronic paper display device that has a vibration member generating vibration of an electronic paper panel and a method of driving the same.

The object of the present invention is to provide an electronic paper display device. The electronic paper display device may include an electronic paper panel that displays an image; and a vibration member that generates vibration of the electronic paper panel.

Herein, the electronic paper panel may include a first electrode disposed on a substrate; twist balls disposed on the first electrode; and a second electrode disposed on the first electrode.

Further, the vibration member may be any one of a linear motor and a piezo element.

Moreover, the vibration member may vibrate the electronic paper panel in at least any one direction of a vertical direction and a horizontal direction to the electronic paper panel.

It is another object of the present invention to provide a method of driving an electronic paper display device. The method of driving the electronic paper display device may include: generating vibration to an electronic paper panel; and applying driving voltage for displaying an image to the electronic paper panel.

Herein, the method of driving the electronic paper display device may further include, before the generating the vibration to the electronic paper panel: discharging the electronic paper panel.

Further, the vibration member may vibrate the electronic paper panel in at least any one direction of a vertical direction and a horizontal direction to the electronic paper panel.

### BRIEF DESCRIPTION OF THE DRAWINGS

FIG. 1 is a cross-sectional view of an electronic paper display device according to a first embodiment of the present invention;

FIG. 2 is an enlarged cross-sectional view of a portion of the electronic paper panel of FIG. 1; and

FIGS. 3 to 5 are cross-sectional views explaining a method of driving an electronic paper display device according to a second embodiment of the present invention.

### DESCRIPTION FOR KEY ELEMENTS IN THE DRAWINGS

100: Electronic paper panel

110: First substrate

120: First electrode

130: Second substrate

140: Second electrode

150: Twist ball

200: Vibration member

300: Driver

### DETAILED DESCRIPTION OF THE PREFERRED EMBODIMENTS

Hereinafter, exemplary embodiments of the present invention will be described in detail with reference to the accompanying drawings of an electronic paper display device. The exemplary embodiments of the present invention to be described below are provided so that those skilled in the art to which the present invention pertains can easily carry out the present invention. Therefore, the present invention may be modified in many different forms and it should not be limited to the embodiments set forth herein. In the drawings, the thickness and the size of the device may be exaggerated for the convenience. Like reference numerals designate like elements throughout the specification.

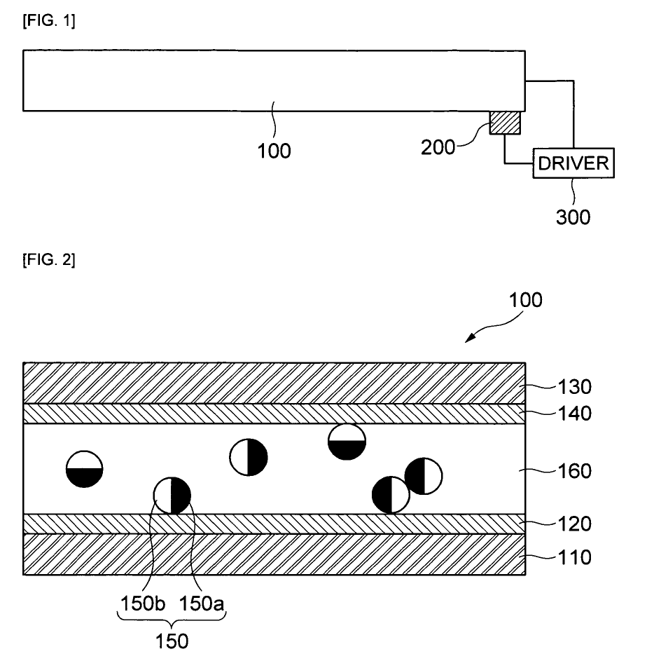

FIG. 1 is a cross-sectional view of an electronic paper display device according to a first embodiment of the present invention.

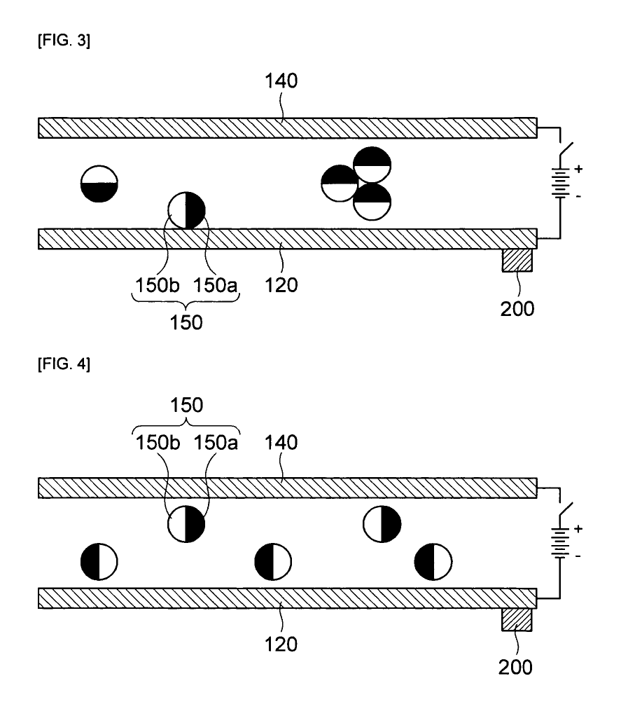

FIG. 2 is an enlarged cross-sectional view of a portion of the electronic paper panel of FIG. 1.

Referring to FIGS. 1 and 2, the electronic paper display device according to an embodiment of the present invention may include an electronic paper panel 100 that displays an image and a vibration member 200.

The electronic paper panel 100 may include twist balls 150 interposed between first and second electrodes 120 and 140.

More specifically, the first electrode 120 may be disposed on a first substrate 110. The material used as the first substrate 110 may include, for example, a plastic substrate, a glass substrate or a film. The first electrode 120 may be formed of metal, for example, Cu or Ag.

The second electrode 140 may be formed on a second substrate 130. Herein, the first and second substrates 110 and 130 may be bonded to each other so that the second electrode 140 faces the first electrode 120.

The second substrate 130 may be formed of transparent material so that light can be transmitted therethrough. For example, the transparent material may include polyethylene terephthalate (PET), polyvinyl alcohol (PVA), polyethylene (PE), polycarbonate (PC), polyacrylate, polymethylmethacrylate, polyurethane, cellulose acetate buthylate (CAB), etc.

The second electrode 140 may be formed of conductive material that can transmit light, for example, ITO, IZO, ITZO, etc.

In the embodiment of the present invention, the second electrode and the second substrate are explained to be limited to the material that can transmit light, but they are not limited thereto. For example, when the second electrode and the second substrate are formed of material that reflects light, the first electrode and the first substrate may be formed of the material that can transmit light.

In addition, although not shown in the drawings, a barrier rib for disposing the twist balls 150 may be further disposed between the first and second electrodes 120 and 140. In other words, the twist balls 150 may be disposed in the region defined by the barrier.

The twist balls 150 may be interposed between the first and second electrodes 120 and 140. At this time, the twist balls 150 may be disposed inside a transparent medium 160 interposed between the first and second electrodes 120 and 140. Herein, the transparent medium 160 may be transparent dielectric liquid. Alternately, the transparent medium 160 may be a transparent dielectric sheet. At this time, the dielectric sheet includes a plurality of cavities, wherein the twist balls 150 may be disposed inside the dielectric liquid filled inside the cavities.

The twist balls 150 may include a first hemisphere 150a that absorbs light and a second hemisphere 150b that reflects the light. Herein, the first hemisphere 150a and the second hemisphere 150b may be charged with different charges. At this time, when different voltages are applied to the first and second electrodes 120 and 140, the twist balls 150 are rotated by a magnetic field formed between the first and second electrodes 120 and 140, such that the electronic paper display device can display characters or images. For example, the first hemisphere 150a may be charged with (+) charges, and the second hemisphere 150b may be charged with (−) charges. At this time, the twist balls 150 may be rotated by an electric field generated between the first and second electrodes 120 and 140 by applying (−) voltage and (+) voltage to the first and second electrodes 120 and 140, respectively. Therefore, the light reflection and the light absorption are selectively performed by the rotation of the twist balls 150, such that the electronic paper display device can display characters or images.

Herein, when power is not applied to the first and second electrodes 120 and 140, the twist balls 150 may be contacted to each other by attraction or the twist balls 150 may be contacted to the first electrode 120 or the second electrode 140.

As described above, when the twist ball 150 is contacted to other twist ball 150 or the first electrode 120 or the second electrode 140, minimum threshold potential for rotating the twist balls 150 cannot but be raised due to the friction force formed on the twist balls 150. Herein, when an electronic paper panel is provided with the barrier rib, such a friction force may also be generated by contact between the twist balls 150 and the barrier rib.

In addition, since a rotation rate when a charge surface of the twist ball 150, that is, the boundary surface between the first and second hemispheres 150a and 150b is installed vertically to an electric field direction should be larger than that when it is installed horizontally thereto, the threshold potential cannot but be raised.

In other words, there is a limit in lowering the minimum threshold potential for starting the rotation of the twist balls 150 due to the friction force for the twist balls 150 or the difference in the rotation rate according to the disposition of the charge surface of the twist balls 150. In conclusion, there is a limit in lowering the driving voltage of the electronic paper display device.

In order to solve this problem, a vibration member 200 that generates vibration to an electronic paper panel 100 is provided.

When the vibration member 200 vibrates the electronic paper panel 100, the twist balls 150 contacted to each other by attraction or the twist balls 150 contacted to the first electrode 120 or the second electrode 140 can be separated from each other. In other words, the friction force of the twist balls 150 can be reduced by the vibration. Further, when the vibration member 200 vibrates the electronic paper panel 100, the direction of the charge surface of the twist ball 150 can be changed.

Therefore, the twist balls 150 are applied with momentum for rotation by the vibration applied from the vibration member 200 so that they can be more easily rotated.

Herein, the vibration member 200 can apply vibration vertically or horizontally to the electronic paper panel 100. However, it is not limited thereto, but if the vibration member 200 gives only momentum for rotating the twist balls 150, the vibration member 200 may apply vibration in any direction of the electronic paper panel.

Further, the vibration member 200 may be a device that can apply vibration to the electronic paper panel 100, for example, a linear motor or a piezo element.

Moreover, the vibration member 200 may be disposed in a region of the electronic paper panel 100 on which an image is not displayed. For example, the vibration member 200 may be disposed in an edge region of the electronic paper panel 100.

In addition, the electronic paper display device may further include a driver 300 that drives the electronic paper panel 100 and the vibration member 200.

The driver 300 can drive the electronic paper panel 100, after driving the vibration member 200. In other words, the electronic paper panel 100 is driven after the momentum for rotating the twist balls 150 of the electronic paper panel 100 is applied, making it possible to lower the threshold potential for rotating the twist balls 150, that is, the driving voltage of the electronic paper display device.

Therefore, in the embodiment of the present invention, the electronic paper display device is provided with the vibration member, making it possible to lower the threshold potential for rotating the twist balls and finally to lower the driving voltage of the electronic paper display device.

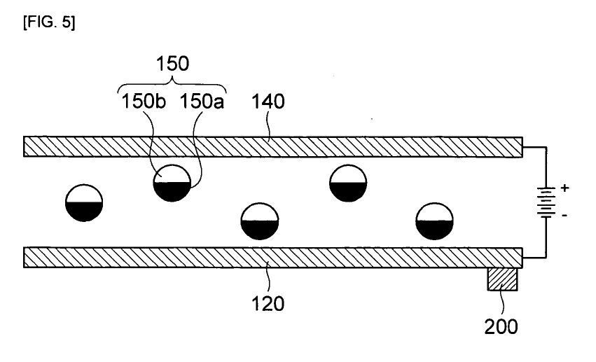

Hereinafter, a method of driving an electronic paper display device according to an embodiment of the present invention will be described in detail with reference to FIGS. 3 to 5. For convenience of explanation, the electronic paper display device is briefly illustrated.

FIGS. 3 to 5 are cross-sectional views explaining a method of driving an electronic paper display device according to a second embodiment of the present invention.

Referring to FIG. 3, the electronic paper display device may include an electronic paper panel 100 that displays an image and a vibration member 200 that vibrates the electronic paper panel 100. The electronic paper display device may further include a driver (300 in FIG. 1) that drives the electronic paper panel 100 and the vibration member 200.

Herein, the electronic paper panel 100 may include twist balls 150 interposed between two electrodes, that is, first and second electrodes 120 and 140. At this time, the twist balls 150 may be contacted to each other or be contacted to the first electrode 120 or the second electrode 140 before the electronic paper panel 100 is driven. Further, the charge surface of the twist ball 150 may be disposed vertically to an electric field direction.

Referring to FIG. 4, the driver 300 drives the vibration member 200 to generate vibration to the electronic paper panel 100. Thereby, the driver 300 can give momentum for rotation to the twist balls 150 provided inside the electronic paper panel 100. In other words, the vibration given to the electronic paper panel 100 can not only reduce the friction force of the twist balls 150 but also change the directin of the charge surface of the twist balls 150, making it possible to lower the threshold potential for rotating the twist balls 150.

Herein, the vibration direction may be vertically or horizontally to the electronic paper panel. However, it is not limited thereto in the embodiment of the present invention.

In addition, before driving the vibration member 200, the driver 300 can discharge the electronic paper panel 100. In other words, the first and second electrodes 120 and 140 of the electronic paper panel 100 are discharged to reduce the attraction of the twist balls for the first and second electrodes 120 and 140, such that the twist balls 150 of the electronic paper panel can be easily separated from each other by the vibration.

Referring to FIG. 5, the driver 300 applies the driving voltage to the electronic paper panel 100, such that the electronic paper panel 100 can display an image. At this time, the twist balls 150 are applied with momentum for rotation by the vibration given to the electronic paper panel 100 so that they are easily rotated even though low driving voltage is applied, making it possible to provide an image to a user.

Therefore, as described in the embodiment of the present invention, the electronic paper display device vibrates the electronic paper panel in order to give the momentum for rotating the twist balls before an image is displayed, making it possible to lower the driving voltage of the electronic paper display device.

The electronic paper display device according to the present invention can reduce the threshold potential for displaying an image, making it possible to reduce power consumption of the electronic paper display device.

Moreover, the electronic paper display device can reduce its power consumption, making it possible to be driven sufficiently with a portable battery.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An electronic paper display device, comprising:
an electronic paper panel that displays an image; and
a vibration member that generates vibration of the electronic paper panel.

2. The electronic paper display device according to claim 1, wherein the electronic paper panel includes:
a first electrode disposed on a substrate;
twist balls disposed on the first electrode; and
a second electrode disposed on the first electrode.

3. The electronic paper display device according to claim 1, wherein the vibration member is any one of a linear motor and a piezo element.

4. The electronic paper display device according to claim 1, wherein the vibration member vibrates the electronic paper panel in at least any one direction of a vertical direction and a horizontal direction to the electronic paper panel.

5. A method of driving an electronic paper display device, comprising:
generating vibration to an electronic paper panel; and
applying driving voltage for displaying an image to the electronic paper panel.

6. The method of driving the electronic paper display device according to claim 5, further comprising, before the generating the vibration to the electronic paper panel:
discharging the electronic paper panel.

7. The method of driving the electronic paper display device according to claim 5, wherein the vibration member vibrates the electronic paper panel in at least any one direction of a vertical direction and a horizontal direction to the electronic paper panel.
